(19) United States
(12) Patent Application Publication
(10) Pub. No.: US 2018/0247273 A1
(43) Pub. Date: Aug. 30, 2018

(54) DYNAMIC SCHEDULE CREATION BASED ON KNOWLEDGE

(71) Applicant: Microsoft Technology Licensing, LLC, Redmond, WA (US)

(72) Inventors: Leela S. Tamma, San Ramon, CA (US); Matthew J. Burdick, Sunnyvale, CA (US); Sandra Quah, Cupertino, CA (US); Robert E. Vreeland, San Jose, CA (US)

(73) Assignee: Microsoft Technology Licensing, LLC, Redmond, WA (US)

(21) Appl. No.: 15/444,451

(22) Filed: Feb. 28, 2017

(51) Int. Cl. G06Q 10/10

(52) U.S. Cl. CPC G06Q 10/1095; G06Q 10/1097

(57) ABSTRACT

Variety of approaches to provide dynamic schedule creation based on a knowledge are described. A hosted service initiates operations to provide dynamic schedule creation upon receiving a request to generate a schedule for a team. Next, a schedule information associated with the team is retrieved from a scheduling data provider. Furthermore, the hosted service retrieves an expertise information and a scheduling preference information associated with the team from a personnel data provider. The schedule is generated based on the scheduling information, the expertise information, and/or the scheduling preference information. The schedule is provided for a presentation to a manager of the team.

### BACKGROUND

Information exchange have changed processes associated with work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modern personal and work environments. Such systems execute a wide variety of applications ranging from enterprise resource management applications to scheme management tools.

Increasingly, cloud based content providers are utilized for managing schedule(s) associated with user(s), where the cloud based content providers have client interface(s) that automatically monitor information associated with the user(s). However, there are currently significant gaps when creating schedule(s) based on a knowledge associated with the user(s). Personnel resources are unnecessarily consumed for creation and management of user schedule(s). Lack of relevant knowledge based schedule creation schemes cause poor management of personnel resources when attempting to generate schedule(s) for user(s).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to dynamic schedule creation based on a knowledge. A hosted service, according to embodiments, may initiate operations to provide dynamic schedule creation upon receiving a request to generate a schedule for a team. Next, a scheduling information associated with the team may be retrieved from a scheduling data provider. Furthermore, an expertise information and a scheduling preference information associated with the team may be retrieved from a personnel data provider. The schedule may be generated based on the scheduling information, the expertise information, and/or the scheduling preference information. The schedule may be provided for a presentation to a manager of the team.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing dynamic schedule creation based on a knowledge, according to embodiments;

FIG. 2 is a display diagram illustrating example components of a hosted service that provides dynamic schedule creation based on a knowledge, according to embodiments;

FIG. 3 is a display diagram illustrating components of a scheme to provide dynamic schedule creation based knowledge, according to embodiments;

FIG. 4 is a display diagram illustrating dynamic schedule creation based on a knowledge, according to embodiments;

FIG. 5 is a simplified networked environment, where a system according to embodiments may be implemented;

FIG. 6 is a block diagram of an example computing device, which may be used to provide dynamic schedule creation based on a knowledge, according to embodiments; and

FIG. 7 is a logic flow diagram illustrating a process for providing dynamic schedule creation based on a knowledge, according to embodiments.

### DETAILED DESCRIPTION

As briefly described above, a hosted service may provide dynamic schedule creation based on a knowledge. In an example scenario, the hosted service may receive a request to generate a schedule for a team. The request may be generated by a manager of the team. The manager may create the team. Alternatively, the hosted service may create the team by selecting members of the team from a pool of candidates who possess attribute(s) matching criteria described in the schedule.

The hosted service may retrieve a scheduling information associated with the team from a scheduling data provider. The scheduling data provider may include a scheduling service that manages schedule(s) of members of the team. The scheduling information may describe availability status of members of the team as partitioned to task(s) within the schedule.

Furthermore, an expertise information and a scheduling preference information associated with the team may be retrieved from a personnel data provider. The personnel data provider may include a data service that hosts and manages portfolios of members of the team that include work related data. The expertise information may include seniority and/or experience, among other information associated with members of the team. The scheduling preference information may include an affinity of a member of the team to work with other members of the team. The scheduling preference information may also include task change, collaboration, and/or completion rate, among other information associated with members of the team.

The hosted service may generate the schedule based on the scheduling information, the expertise information, and/or the scheduling preference information. The hosted service may also evaluate performance information associated with members of the team when assigning tasks within the schedule to the members of the team. The schedule may be transmitted to the manager of the team.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing dynamic schedule creation based on a knowledge. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

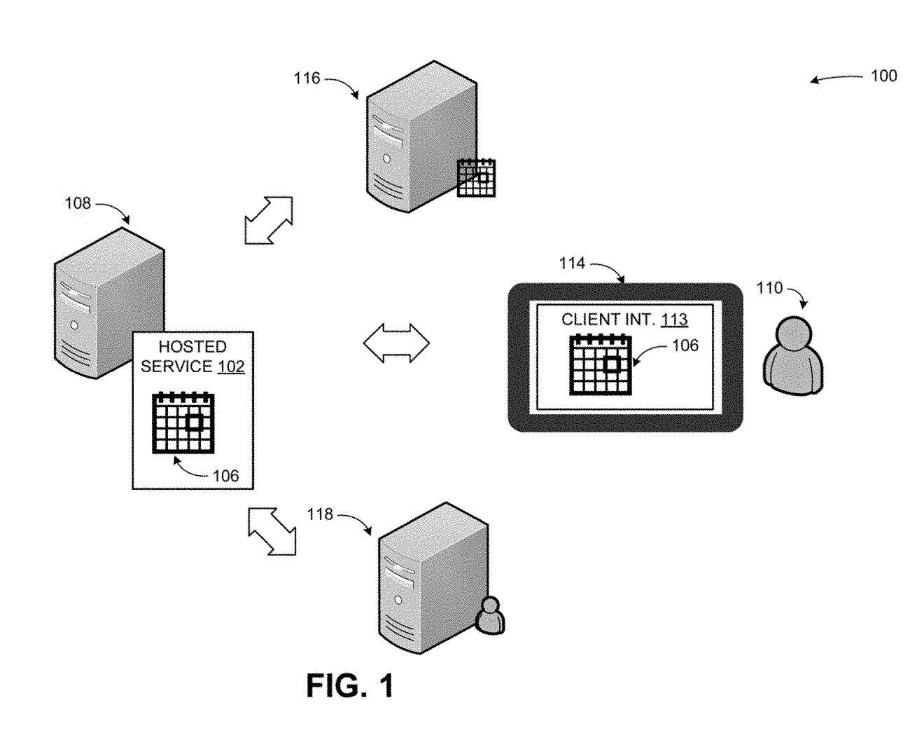

FIG. 1 is a conceptual diagram illustrating examples of providing dynamic schedule creation based on a knowledge, according to embodiments.

In a diagram 100, a server 108 may execute (or provide) a hosted service 102. The server 108 may include a physical server providing service(s) and/or application(s) to client devices. A service may include an application performing operations in relation to a client application and/or a subscriber, among others. The server 108 may include and/or is part of a workstation, a data warehouse, a data center, and/or a cloud based distributed computing source, among others.

The server 108 may execute the hosted service 102. The hosted service 102 may initiate operations to provide dynamic schedule creation upon receiving a request to generate a schedule 106 for a team. The request may be generated by a manager 110 of the team. The manager may interact with a client interface 113 of the hosted service 102 (or a client application) to generate the schedule 106. The client interface 113 of the hosted service 102 may be rendered by a client device 114. The manager 110 may create the team through the client interface 113. Alternatively, the hosted service 102 may create the team by selecting members of the team from a pool of candidates who possess attribute(s) matching criteria defined in the schedule 106. The manager 110 may define the criteria (such as skill requirement for a task within the schedule 106).

The hosted service 102 may employ a machine learning scheme to process and evaluate knowledge associated with the team to generate the schedule 106. The knowledge may include a scheduling information, an expertise information, a scheduling preference information, and/or a performance information associated with the team. The hosted service 102 may retrieve the scheduling information associated with the team from a scheduling data provider 116. The scheduling data provider 116 may include a scheduling service that manages schedule(s) of members of the team. The scheduling information may describe availability status of members of the team as partitioned to task(s) within the schedule 106.

Furthermore, the expertise information and the scheduling preference information associated with the team may be retrieved from a personnel data provider 118. The personnel data provider 118 may include a data service that hosts and manages portfolios of members of the team that include work related data. The expertise information may include seniority and/or experience, among other information associated with members of the team. The scheduling preference information may include an affinity of a member of the team to work with other members of the team. The scheduling preference information may also include task change, collaboration, and/or completion rate, among other information associated with members of the team.

The hosted service 102 may generate the schedule based on the scheduling information, the expertise information, and/or the scheduling preference information. The hosted service 102 may also evaluate performance information associated with members of the team when assigning tasks within the schedule 106 to the members of the team. The schedule 106 may be transmitted to the manager of the team.

The server 108 may communicate with the client device 114, the scheduling data provider 116, and/or the personnel data provider 118 through a network. The network may provide wired or wireless communications between network nodes such as the client device 114, the server 108, the scheduling data provider 116, and/or the personnel data provider 118, among others. Previous example(s) to provide dynamic schedule creation based on a knowledge are not provided in a limiting sense. Alternatively, the hosted service 102 may provide the schedule 106 to the manager 110 as a desktop application, a workstation application, and/or a server application, among others. The client interface 113 may also include a client application interacting with the hosted service 102.

The manager 110 may interact with the client interface 113 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the hosted service 102, embodiments are not limited to these components or system configurations and can be implemented with other system configuration employing fewer or additional components.

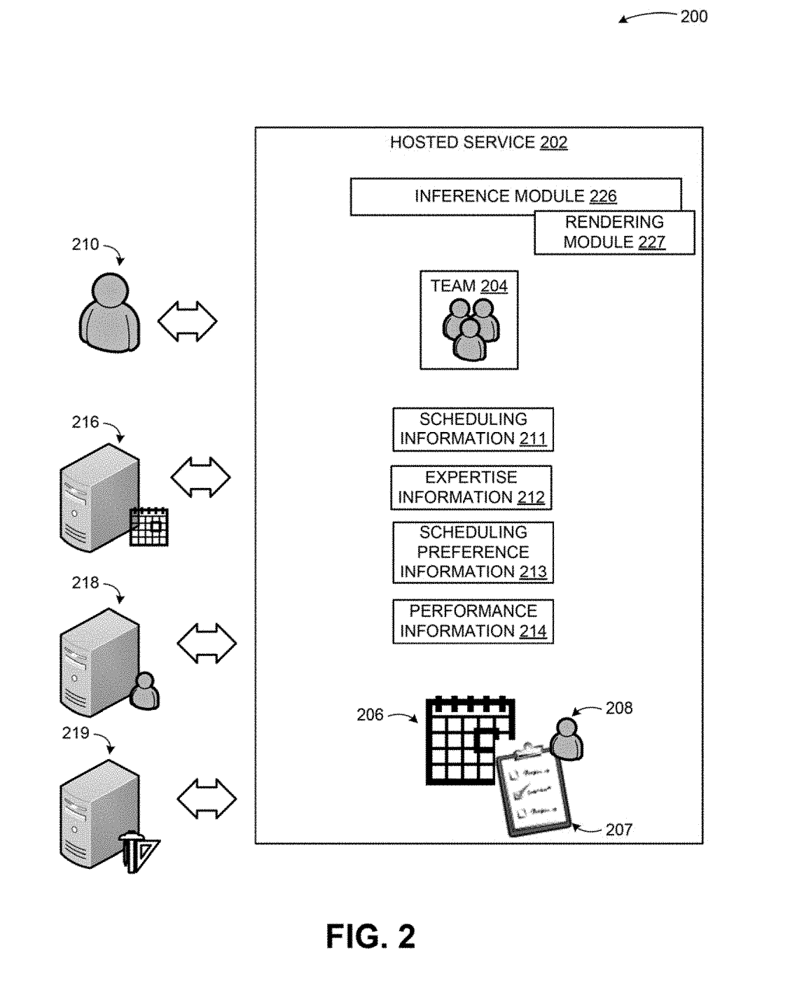

FIG. 2 is a display diagram illustrating example components of a hosted service that provides dynamic schedule creation based on a knowledge, according to embodiments.

As illustrated in diagram 200, an inference module 226 of a hosted service 202 may generate a schedule 206 by processing knowledge associated with members of a team 204. The knowledge may include a scheduling information 211, an expertise information 212, a scheduling preference information 213, and/or a performance information 214 associated with members of the team 204. A manager 210 of the team 204 may request the schedule 206 for the team. The manager 210 may select member of the team 204. Alternatively, the inference module 226 may select the members of the team 204 from a pool of candidates based on attributes of the members that match criteria of the schedule 206 defined in the request. The manager 210 may define the criteria associated with the schedule 206 such as a duration, task(s) within the schedule, and/or a skill and other property of the task(s) that are necessary for a completion of the task(s), among other things.

In an example scenario, the inference module 226 may retrieve the scheduling information 211 from a scheduling data provider 216. The scheduling data provider 216 may host availability status associated with members of the team 204. For example, the scheduling data provider 216 may host and manage calendar(s) of members of the team 204 which describe the availability status of the members. The availability status may be partitioned by timeslots which span a duration of the schedule 206. The inference module 226 may consider an availability status of a member 208 of the team when assigning the member 208 to a timeslot of a task 207 within the schedule 206.

Furthermore, the inference module 226 may retrieve an expertise information 212 associated with members of the team 204 from a personnel data provider 218. For example, the personnel data provider 218 may host and manage profile(s) associated with members of the team 204. The profile(s) may include seniority, and/or expertise, among other attribute associated with members of the team 204. The inference module 226 may consider the seniority and/or the expertise of the member 208 when assigning the member 208 to the timeslot of the task 207 within the schedule.

The inference module 226 may also retrieve the scheduling preference information 213 associated with members of the team 204 from the personnel data provider 218. For example, the profile(s) associated with the members of the team 204 may include a request by the member 208 to be assigned the timeslot for the task 207. The inference module 226 may consider the request by the member 208 when assigning the member 208 to the timeslot of the task 207.

Moreover, the inference module 226 may retrieve a performance information 214 associated with members of the team 204 from a metrics provider 219. The metrics provider 219 may host and manage quantifiable measurements associated with a performance of previous task(s) by the members of the team 204. For example, the metrics provider 219 may host and manage a performance metric of the members of the team 204 captured during a performance of previous task(s). The performance metric may include a completion status, a duration of a previous task, and/or a quality of work-product, among other metrics associated with the previous task(s). The inference module 226 may consider the performance metric associated with the member 208 when assigning the member 208 to the task 207.

A rendering module 227 may transmit the schedule 206 to the manager 210. The rendering module 227 may also receive an update to the schedule 206 from the manager 210. The update may include a change to the task (or other task(s)) such as re-assignment of the member 208 to other task(s). The update may be incorporated into the schedule 206 by the inference module 226.

In addition to retrieving and analyzing information from the scheduling data provider 216, the personnel data provider 218, and/or the metrics provider 219, the inference module 226 may instruct the data provider(s) to collect information associated with the member of the team 204 during a performance of task(s) within the schedule 206. The inference module 226 may retrieve the collected information for an analysis of a performance of the task(s) within the schedule 206. A knowledge model may be created from the analysis to generate a future schedule, and/or optimize an existing schedule for the team 204.

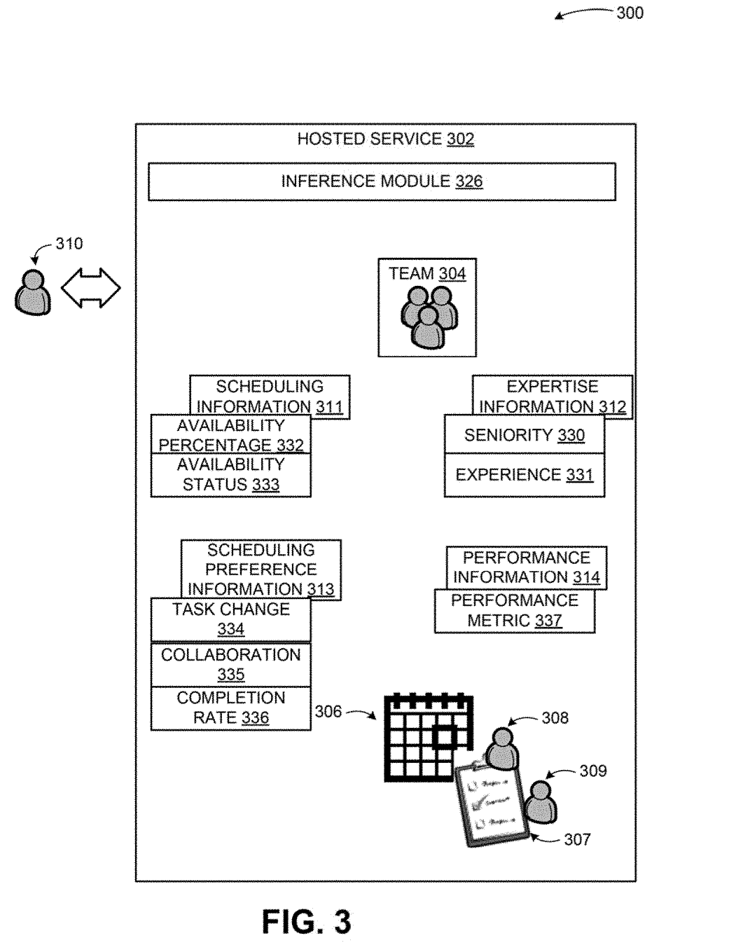

FIG. 3 is a display diagram illustrating components of a scheme to provide dynamic schedule creation based on a knowledge, according to embodiments.

As shown in a diagram 300, an inference module 326 of a hosted service 302 may generate a schedule 306 for a team 304 upon detecting an intent by a manager 310 to generate the schedule 306. The intent may include a repeat event (such as an upcoming work-shift) which may necessitate the schedule 306 to assign tasks to members of the team 304. The manager 310 may select the team 304. Alternatively, the inference module 326 may select the members of the team 304 from a pool of candidates who have attributes matching criteria of the schedule 306 (such as availability within the duration of the schedule 306).

In an example scenario, the inference module 326 may initiate operations to generate the schedule 306 by retrieving a scheduling information 311 from a scheduling data provider. The scheduling information 311 may provide availability information associated with the members of the team 304. For example, a member 308 may be identified to have an availability percentage 332 during a span of the schedule 306. The availability percentage 332 may describe a percentage of timeslots of the schedule 306 for which an availability status 333 of the member 308 is designated as available. The inference module 326 may assign a task 307 within the schedule 306 to the member 308 if the availability percentage 332 of the member 308 exceeds an availability threshold designated to the schedule 306. Alternatively, the inference module 326 may assign the task 307 to the member 308 if the availability status 333 of the member 308 is designated as available.

The inference module 326 may also detect a member 309 with the availability status 333 designated as available for the timeslot of the task 307. The inference module 326 may compare attribute of the member 308 to the attribute of the member 309 associated with the scheduling information 311. The attribute may include the availability percentage 332, the availability statue 333 and/or other availability status in adjacent task(s). The member 309) may be selected for the task 307 based on the comparison. The task 307 may be re-assigned to the member 309.

The inference module may also analyze expertise information 312 associated with members of the team 304. For example, a seniority and/or an experience 331 of a member 308 may be considered when assigning the task 307 to the member 308. The experience 331 may describe performance of the member 308 with previous task(s) that are related and/or similar to the task 307. The seniority 330 may describe a length of involvement of the member 308 with the team and/or an organization encapsulating the team 304. The inference module 326 may assign the task 307 to the member 308 based on the seniority 330 and/or the experience 331 of the member 308.

The inference module 326 may also compare attribute of the member 308 to the attribute of the member 309 associated with the expertise information 312. The attribute may include the seniority 330 and/or the experience 331. The member 309 may be selected based on the attribute associated with the expertise information 312. The task 307 may be re-assigned to the member 309.

In an example scenario, the inference module 326 may analyze scheduling preference information 313 associated with members of the team 304 to generate the schedule 306. For example, the scheduling preference information may describe an affinity (a desire) of the member 308 to be assigned the timeslot of the task 307. Furthermore, attributes associated with the member 308 may be considered when assigning the task 307 to the member 308. The attributes may include a task change 334, a collaboration 335, and a completion rate 336.

The task change 334 may include multiple metrics such as a number of previous successful task changes and/or previous unsuccessful task changes (which may be used to predict a likelihood of a task change request for the task 307 from the member 308). The collaboration 335 may describe an affinity of the member 308 to work with other members of the team 304 for the task 307 or other task(s) within the schedule 306. The completion rate 336 may describe a rate of completion of previous task(s) by the member 308 (which may be used to predict a likelihood of completion of the task 307 by the member 308). The affinity of the member 308 and attributes associated with the member 308 within the scheduling preference information 313 may be considered to assign the task 307 to the member 308.

The inference module 326 may identify a member 309 with an affinity (a desire) to be assigned the timeslot of the task 307. The inference module 326 may compare the attributes of the member 308 to the attributes of the member 309 associated with the scheduling preference information 313. The member 309 may be selected based on the comparison. As a result, the task 307 may be re-assigned to the member 309.

The inference module 326 may analyze a performance information 314 associated with the team 304 to generate the schedule 306. For example, a performance metric 337 of a member 308 may be considered when assigning a task 307 to the member 308. The performance metric 337 may include quantifiable measurements associated with performance of previous tasks (that may be related and/or similar to the task 307). An example of the performance metric 337 may include a completion status, a duration of a previous task, and/or a quality of work-product, among other metrics associated with the previous task(s). The member 308 may be assigned the task 307 based on the performance metric 337 that exceeds a performance threshold designated to the task 307.

The inference module 326 may compare the performance metric 337 of a member 309 to the performance metric 337 of the member 308. The member 309 may be selected based on the performance metric 337 (that exceeds that of the member 308). As a result, the task 307 may be re-assigned to the member 309.

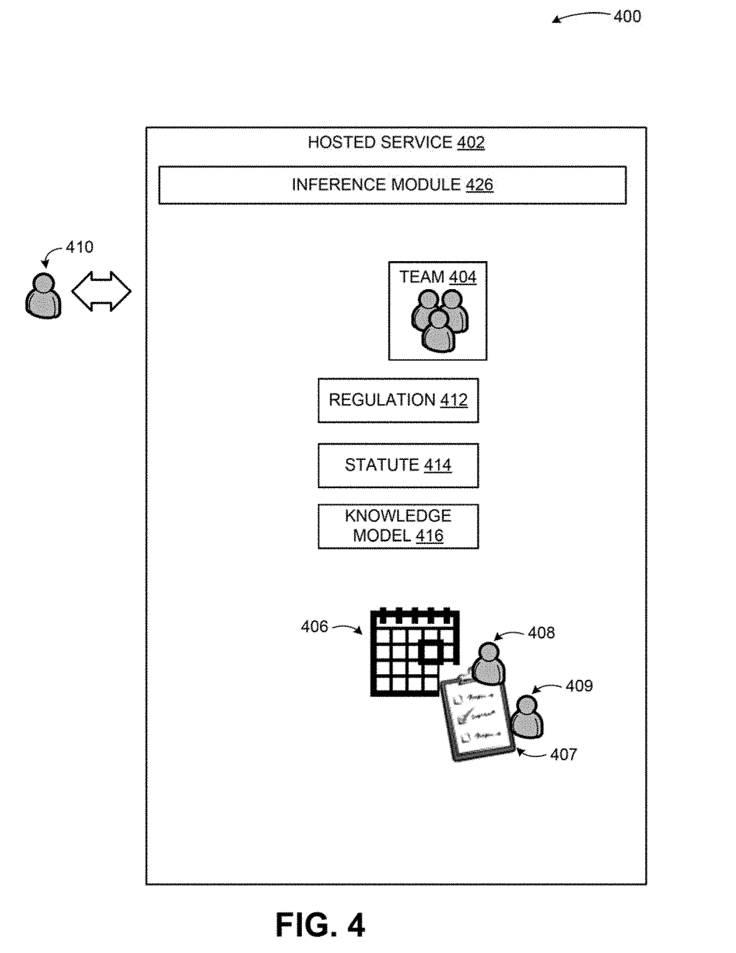

FIG. 4 is a display diagram illustrating dynamic schedule creation based on a knowledge, according to embodiments.

As shown in a diagram 400, an inference module 426 of a hosted service 402 may detect a violation of a regulation 412 and/or a statute 414 impacting the schedule 406. For example, the statute 414 may define a designated number of hours members of the team 404 may work with a regular pay rate. The team members may be subject to overtime pay rate above the designated number of hours. A regulation 412 may describe break time(s) during a time period in which the members of the team 404 are working.

The inference module 426 may identify an assignment of a member 408 of the team 404 to a task 407 (within the schedule 406) that violates the regulation 412 and/or the statute 414. In response, the assignment of the member 408 to the task 407 may be removed to remedy the violation. Furthermore, a member 409 may be identified with an availability state designated as available during the timeslot of the task. A proposed assignment of the member 409 to the task 407 may be analyzed to be in a compliance with the regulation 412 and/or the statute 414. As such, the member 409 may be assigned to the task 407.

The inference module 426 may also generate a knowledge model 416 based on the schedule 406. The knowledge model 416 may be used to generate a future schedule for the team 404. The knowledge model 416 may include task assignment information associated with the team. The knowledge model 416 may also be updated based on performance information associated with the tasks of the schedule 406. For example, on time and successful completion of tasks may be recorded in the model to reconstruct similar task assignments in future schedules. Alternatively, re-assignment suggestions may be recorded in the knowledge model 416 for tasks that were poorly performed or not performed.

Other information signals retrieved from other data providers or inferred based on available data may be considered when assigning members of the team 404 to the tasks within the schedule 406. For example, weather information may be considered when scheduling the members to the tasks (such as weather events that may prevent a completion of a task). Communications of the members may also be processed to update available information or use as new source of information to consider when assigning the tasks to the members of the team 404 (such as when a member of the team 404 communicates a desire for time off that overlaps an assigned task). Roles and other organizational responsibilities may also be evaluated when identifying members of the team to assign to tasks that necessitate skills associated with the roles and responsibilities.

As discussed above, the hosted service may be employed to perform operations to automate schedule creation based on a knowledge. An increased performance and efficiency improvement with the hosted service 102 may occur as a result of processing scheduling, expertise, scheduling preference and/or performance information to assign members of a team to tasks within a schedule. Additionally, dynamically optimizing assignment operations to improve task completion, by the hosted service 102, may reduce processor load, increase processing speed, conserve memory, and reduce network bandwidth usage.

Embodiments, as described herein, address a need that arises from a lack of efficiency to provide dynamic schedule creation based on a knowledge. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing dynamic schedule creation based on a knowledge may be implemented in configurations employing fewer or additional components in applications and user interfaces. Furthermore, the example schema and components shown in FIG. 1 through 4 and their subcomponents may be implemented in a similar manner with other values using the principles described herein.

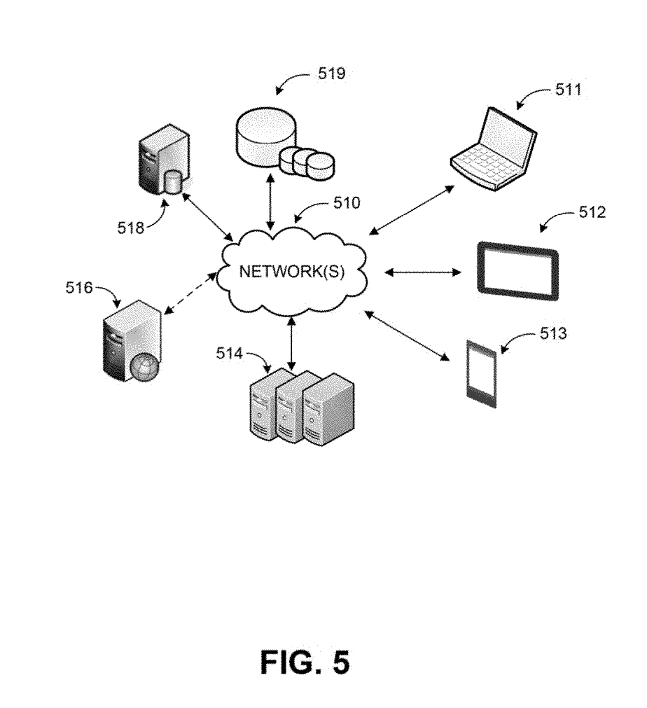

FIG. 5 is an example networked environment, where embodiments may be implemented. A hosted service configured to provide dynamic schedule creation may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A hosted service may receive a request to generate a schedule for a team. Next, a scheduling information associated with the team may be retrieved from a scheduling data provider. Furthermore, an expertise information and a scheduling preference information associated with the team may be retrieved from a personnel data provider. The schedule may be generated based on the scheduling information, the expertise information, and/or the scheduling preference information. The schedule may be provided for a presentation to a manager of the team. The hosted service may store data associated with the schedule in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide dynamic schedule creation based on a knowledge. Furthermore, the networked environments discussed in FIG. 5 are for illustration purposes only. Embodiments are not limited to the example applications, modules, or processes.

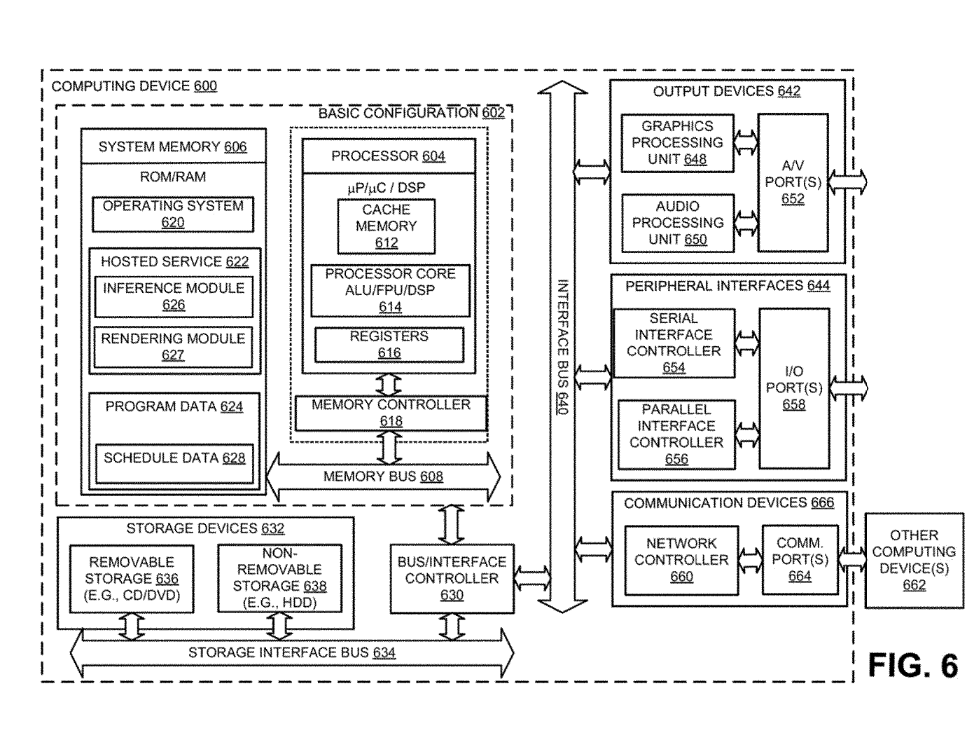

FIG. 6 is a block diagram of an example computing device, which may be used to provide dynamic schedule creation based on a knowledge, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), a graphics processing unit (GPU), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a hosted service 622, and a program data 624. The hosted service 622 may include a component such as an inference module 626 and a rendering module 627. The inference module 626 and the rendering module 627 may execute the processes associated with the hosted service 622. The content module 626 may receive a request to generate a schedule for a team. Next, a scheduling information associated with the team may be retrieved from a scheduling data provider. Furthermore, an expertise information and a scheduling preference information associated with the team may be retrieved from a personnel data provider. The schedule may be generated based on the scheduling information, the expertise information, and/or the scheduling preference information. The rendering module 627 may transmit the schedule to a manager of the team for a presentation.

Input to and output out of the hosted service 622 may be transmitted through a communication module associated with the computing device 600. An example of the communication module may include a communication device 666 that may be communicatively coupled to the computing device 600. The communication module may provide wired and/or wireless communication. The program data 624 may also include, among other data, schedule data 628, or the like, as described herein. The schedule data 628 may include scheduling, expertise, scheduling preference, and/or performance information, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus (40 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide dynamic schedule creation based on a knowledge. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

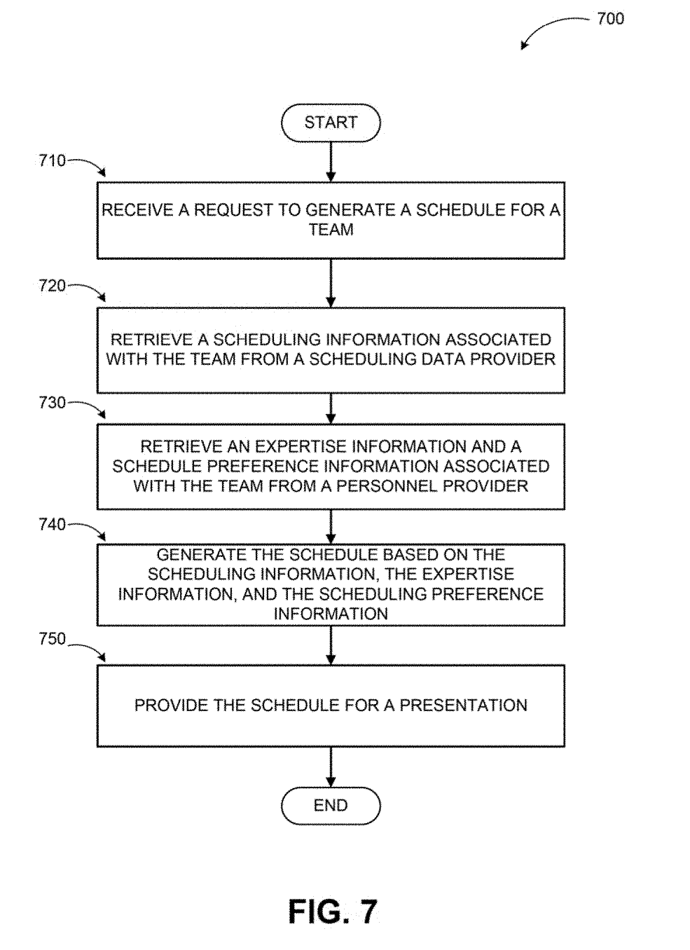

FIG. 7 is a logic flow diagram illustrating a process for providing dynamic schedule creation based on a knowledge, according to embodiments. Process 700 may be implemented on a computing device, such as the computing device 600 or another system.

Process 700 begins with operation 710, where the hosted service may receive a request to generate a schedule for a team. At operation 720, the hosted service may retrieve a scheduling information associated with the team from a scheduling data provider. The scheduling data provider may include a scheduling service that manages schedule(s) of members of the team.

At operation 730, an expertise information and a scheduling preference information associated with the team may be retrieved from a personnel data provider. The personnel data provider may include a data service that hosts and manages portfolios of members of the team that include work related data. At operation 740, the hosted service may generate the schedule based on the scheduling information, the expertise information, and/or the scheduling preference information. The hosted service may also evaluate performance information associated with members of the team when assigning tasks within the schedule to the members of the team. At operation 750, the schedule may be transmitted to the manager of the team.

The operations included in process 700 is for illustration purposes. Providing dynamic schedule creation based on a knowledge may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a method executed on a computing device to provide dynamic schedule creation based on a knowledge is described. The method includes receiving a request to generate a schedule for a team, retrieving a scheduling information associated with the team from a scheduling data provider, retrieving an expertise information and a scheduling preference information associated with the team from a personnel data provider, generating the schedule based on the scheduling information, the expertise information, and the scheduling preference information, and providing the schedule for a presentation.

In other examples, the method further includes identifying a sender of the request as a manager of the team and detecting a task within the schedule, wherein the task is assigned a timeslot within the schedule. The method further includes detecting a skill as a completion condition associated with the task, analyzing the expertise information to identify a first member of the team with the skill, and assigning the task to the first member of the team. The method further includes detecting a second member of the team with the skill in the expertise information, comparing the first member to the second member of the team based on an attribute associated with the expertise information, selecting the second member of the team based on the attribute associated with the expertise information, and re-assigning the task to the second member of the team. The attribute includes a seniority and an experience related to the task.

In further examples, the method further includes analyzing the scheduling information to identify a first member of the team with an availability status designated as available during a timeslot of the task and assigning the task to the first member of the team. The method further includes detecting a second member of the team with the availability status designated as available during the timeslot of the task and comparing the first member to the second member of the team based on an attribute associated with the scheduling information, selecting the second member of the team based on the attribute associated with the scheduling information, and re-assigning the task to the second member of the team. The attribute associated with the scheduling information includes an availability percentage during a span of the schedule and the availability status.

In other examples, the method further includes analyzing the scheduling preference information to identify a first member of the team with an affinity for the task and assigning the task to the first member of the team. The method further includes detecting a second member of the team with the affinity to the task, comparing the first member to the second member of the team based on an attribute associated with the scheduling preference information, selecting the second member of the team based on the attribute associated with the scheduling preference information, and re-assigning the task to the second member of the team. The attribute associated with the scheduling preference information includes a number of previous successful task changes, a number of previous unsuccessful task changes, a collaboration with other member of the team in related tasks, and a completion rate of the related tasks.

In some examples, a server configured to provide dynamic schedule creation based on a knowledge is described. The server includes a communication module configured to facilitate communication between a hosted service and one or more client devices, a memory configured to store instructions, and a processor coupled to the memory and the communication module. The processor executes the hosted service in conjunction with the instructions stored in the memory. The hosted service includes an inference module and a rendering module. The inference module is configured to detect an intent to generate a schedule for a team by a manager of the team, retrieve a scheduling information associated with the team from a scheduling data provider, retrieve an expertise information associated with the team from a personnel data provider, retrieve a performance information associated with the team from a metrics provider, generate the schedule based on the scheduling information, the expertise information, and the performance information associated with the team. The rendering module is configured to transmit the schedule to the manager.

In other examples, the inference module is further configured to identify a performance threshold as a property of a task within the schedule; analyze the performance information to identify a first member of the team with a performance metric exceeding the performance threshold of the task, and assign the task to the first member of the team. The inference module is further configured to identify a second member of the team with an availability status designated as available during a timeslot of the task, detect a performance metric of the second member of the team exceed the performance metric of the first member of the team, and re-assign the task to the second member of the team.

In further examples, the inference module is further configured to detect a violation of one or more of a regulation and a statute impacting the schedule; identify an assignment of a first member of the team to a task within the schedule, wherein the assignment violates the one or more of the regulation and the statute impacting the schedule, and remove the assignment of the first member of the team to the task. The inference module is further configured to identify a second member of the team with an availability status designated as available during a timeslot of the task and assign the second member of the team to the task. The inference module is further configured to generate a knowledge model based on the schedule, detect other intent to generate other schedule for the team, and create the other schedule based on the knowledge model.

In some examples, computer-readable memory device with instructions stored thereon to provide dynamic schedule creation based on a knowledge is described. The instructions include actions similar to the actions provided by the inference module and rendering module of the hosted service provided by the server.

In some examples a means for providing dynamic schedule creation based on a knowledge is described. The means for providing dynamic schedule creation based on a knowledge includes a means for receiving a request to generate a schedule for a team, a means for retrieving a scheduling information associated with the team from a scheduling data provider, a means for retrieving an expertise information and a scheduling preference information associated with the team from a personnel data provider, a means for generating the schedule based on the scheduling information, the expertise information, and the scheduling preference information, and a means for providing the schedule for a presentation.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide dynamic schedule creation based on a knowledge, the method comprising:
receiving a request to generate a schedule for a team;
retrieving a scheduling information associated with the team from a scheduling data provider;
retrieving an expertise information and a scheduling preference information associated with the team from a personnel data provider;
generating the schedule based on the scheduling information, the expertise information, and the scheduling preference information; and
providing the schedule for a presentation.

2. The method of claim 1, further comprising:
identifying a sender of the request as a manager of the team; and
detecting a task within the schedule, wherein the task is assigned a timeslot within the schedule.

3. The method of claim 2, further comprising:
detecting a skill as a completion condition associated with the task;
analyzing the expertise information to identify a first member of the team with the skill; and
assigning the task to the first member of the team.

4. The method of claim 3, further comprising:
detecting a second member of the team with the skill in the expertise information;
comparing the first member to the second member of the team based on an attribute associated with the expertise information;
selecting the second member of the team based on the attribute associated with the expertise information; and
re-assigning the task to the second member of the team.

5. The method of claim 4, wherein the attribute includes a seniority and an experience related to the task.

6. The method of claim 2, further comprising:
analyzing the scheduling information to identify a first member of the team with an availability status designated as available during a timeslot of the task; and
assigning the task to the first member of the team.

7. The method of claim 6, further comprising:
detecting a second member of the team with the availability status designated as available during the timeslot of the task;
comparing the first member to the second member of the team based on an attribute associated with the scheduling information;
selecting the second member of the team based on the attribute associated with the scheduling information; and
re-assigning the task to the second member of the team.

8. The method of claim 7, wherein the attribute associated with the scheduling information includes an availability percentage during a span of the schedule and the availability status.

9. The method of claim 2, further comprising:
analyzing the scheduling preference information to identify a first member of the team with an affinity for the task; and
assigning the task to the first member of the team.

10. The method of claim 9, further comprising:
detecting a second member of the team with the affinity to the task;
comparing the first member to the second member of the team based on an attribute associated with the scheduling preference information;
selecting the second member of the team based on the attribute associated with the scheduling preference information; and
re-assigning the task to the second member of the team.

11. The method of claim 10, wherein the attribute associated with the scheduling preference information includes a number of previous successful task changes, a number of previous unsuccessful task changes, a collaboration with other member of the team in related tasks, and a completion rate of the related tasks.

12. A server configured to provide dynamic schedule creation based on a knowledge, the server comprising:
a communication module configured to facilitate communication between a hosted service and one or more client devices;
a memory configured to store instructions; and
a processor coupled to the memory and the communication module, the processor executing the hosted service in conjunction with the instructions stored in the memory, wherein the hosted service includes:
an inference module configured to:
detect an intent to generate a schedule for a team by a manager of the team;
retrieve a scheduling information associated with the team from a scheduling data provider;
retrieve an expertise information associated with the team from a personnel data provider;
retrieve a performance information associated with the team from a metrics provider;
generate the schedule based on the scheduling information, the expertise information, and the performance information associated with the team; and
a rendering module configured to:
transmit the schedule to the manager.

13. The server of claim 12, wherein the inference module is further configured to:
identify a performance threshold as a property of a task within the schedule;
analyze the performance information to identify a first member of the team with a performance metric exceeding the performance threshold of the task; and
assign the task to the first member of the team.

14. The server of claim 13, wherein the inference module is further configured to:
identify a second member of the team with an availability status designated as available during a timeslot of the task;
detect a performance metric of the second member of the team exceed the performance metric of the first member of the team; and
re-assign the task to the second member of the team.

15. The server of claim 12, wherein the inference module is further configured to:
detect a violation of one or more of a regulation and a statute impacting the schedule;
identify an assignment of a first member of the team to a task within the schedule, wherein the assignment violates the one or more of the regulation and the statute impacting the schedule; and
remove the assignment of the first member of the team to the task.

16. The server of claim 15, wherein the inference module is further configured to:
identify a second member of the team with an availability status designated as available during a timeslot of the task; and
assign the second member of the team to the task.

17. The server of claim 12, wherein the inference module is further configured to:
generate a knowledge model based on the schedule;
detect other intent to generate other schedule for the team; and
create the other schedule based on the knowledge model.

18. A computer-readable memory device with instructions stored thereon to provide dynamic schedule creation based on a knowledge, the instructions comprising:
detecting an intent to generate a schedule for a team by a manager of the team;
retrieving a scheduling information associated with the team from a scheduling data provider;
retrieving an expertise information associated with the team from a personnel data provider;
retrieving a performance information associated with the team from a metrics provider;
generating the schedule based on the scheduling information, the expertise information, and the performance information associated with the team; and
providing the schedule to the manager.

19. The computer-readable memory device of claim 18, wherein the instructions further comprise:
analyzing the scheduling information to identify members of the team with an availability status designated as available during a timeslot of the task;
ranking the members of the team based on a performance metric associated with one or more related tasks;
selecting a top performing member from the members of the team, wherein the top performing member is ranked above other members of the team; and
assigning the task to the top performing member of the team.

20. The computer-readable memory device of claim 18, wherein the instructions further comprise:
detecting a violation of one or more of a regulation and a statute impacting the schedule,
identifying an assignment of a first member of the team to a task within the schedule, wherein the assignment violates the one or more of the regulation and the statute impacting the schedule;
removing the assignment of the first member of the team to the task;
identifying a second member of the team with an availability status designated as available during a timeslot of the task,
detecting a proposed assignment of the second member of the team to the task as in a compliance of the one or more of the regulation and the statute impacting the schedule; and
assigning the second member of the team to the task.
